(19) United States
(12) Patent Application Publication
(10) Pub. No.: US 2008/0062515 A1
(43) Pub. Date: Mar. 13, 2008

(54) Telescope Mount

(76) Inventors: Peter Aniol, Fischach (DE); Mario Costantino, Starnberg (DE)

Correspondence Address: 24IP LAW GROUP USA, PLLC, 12 E. LAKE DRIVE, ANNAPOLIS, MD, 21403, US

(21) Appl. No.: 11/853,120

(22) Filed: Sep. 11, 2007

(30) Foreign Application Priority Data
Sep. 11, 2006 (EP) 06 019 000.6

(51) Int. Cl. G02B 23/16

(52) U.S. Cl. 359/429

(57) ABSTRACT

Apparatus for the rotatable mount of a telescope having at least two axes being substantially orthogonal to each other, wherein the telescope is rotatable about at least a first axis of the two orthogonal axes by at least a first rotation device, the rotation device comprising a first working shaft and a first driven shaft of a first drive wherein the respective axis of the first working shaft and the first driven shaft are aligned and formed integrally.

### CROSS-REFERENCE TO RELATED APPLICATIONS

The present application claims priority to and the benefit of the filing date of European Patent Application Serial No. EP 06 019 000.6 filed on Sep. 11, 2006.

### STATEMENT REGARDING FEDERALLY SPONSORED RESEARCH OR DEVELOPMENT

None.

### BACKGROUND OF THE INVENTION

1. Field Of The Invention

The present invention relates to telescope mounts. In particular, the invention relates to motor driven telescope mounts.

2. Brief Description Of The Related Art

Telescopes of any size for the observation of the sky and stars from the earth are usually rotatably mounted by means of at least two axes. Telescope mounts are used on one hand to direct the telescope quickly to an object, i.e., a celestial object to be observed and on the other hand to observe this object over a continued period of time independently of the rotation of the earth. Systems for continuous observation of a celestial object are known, by which the telescope can automatically follow/guide celestial objects and thereby can compensate the rotation of the earth.

A plurality of mounts for telescopes are known, such as different types like equatorial mounts, Altitude-Azimuth-Mounts (Alt-Az-mounts) or Alt-Alt-mounts or such as different designs like fork mounts, German-type mounts, or mounts with bended pier and others.

Using an equatorial mount, the telescope is supported rotatably about two axes that are perpendicular with respect to each other, wherein the axes are oriented such that a first axis, the right ascension axis, is oriented parallel to the rotational axis of the earth and a second axis, the declination axis, is oriented perpendicular to the first axis. Thus, the second axis allows pivoting the telescope from a celestial pole to the other. Once the equatorial mount is adjusted with respect to one celestial object, it has to be rotated about only one axis during observation, the one axis being the right ascension axis for guiding the object to be observed (compensation of the earth's rotation).

Using an altitude-azimuth mount (Alt-Az-mount), the telescope is also supported rotatably about two perpendicular axes, wherein the axes are oriented such that one axis, the azimuth axis, is vertically oriented perpendicular to the horizon, and the second axis, the altitude-axis or elevation axis, is perpendicular to the first axis thereby allowing to pivot or move the observation direction of the telescope from the horizon to the zenith. This type of mount is mechanically simpler but has to be continuously rotated or pivoted about both axes with varying velocities to guide a celestial object (compensation of the rotation of the earth).

Using an Alt-Alt-mount the telescope is also supported rotatably about two axes being perpendicular with respect to each other, wherein the axes are oriented such that the first axis is horizontally oriented parallel to the horizon and the second axis is perpendicular to the first axis. The Alt-Alt-type has particular advantages for observing the zenith.

Mounts that are available today often have motor driven axes, in particular driven by an electric motor and have corresponding controls, by which the telescope can be positioned or directed quickly to a celestial object to be observed and by which the positioned celestial object can be subsequently observed over a long period of time without having to guide or readjust the telescope manually and without time consuming readjustments.

Standard electric motors are used for the rotation of a telescope about the corresponding axis in prior art, the electric motors being connected via gears, belts or other power transmission means to the corresponding shaft of the mount; thereby, depending on the gear or transmission, a high positioning velocity can be preferred for quickly finding and adjusting the telescope to a particular celestial object or, alternatively, a high positioning accuracy and an exact positioning on a celestial object can be preferred. In state of the art systems, a compromise has to be found between a high precision in positioning and guiding on one side and a high positioning velocity on the other side.

Commonly known drives, by which the force is transmitted via gears, for example worm gears, onto the shaft, have mechanical disadvantages which have a negative influence on the positioning and guiding precision of the mount, i.e., caused by periodic worm gear errors, internal backlash or gear backlash, hysteresis when inverting the direction of rotation, different friction for example in different operating temperatures (telescopes are often used outside), and others.

In case it is desired to optimize high positioning velocities and positioning accuracy at the same time, a high constructive effort is necessary in systems according to the state of the art, for example by optimizing transmissions or gears and of the regulating motors, leading to high costs and expensive materials. In addition, transmissions and motors attached to the housing of the mount are often very large in size and can limit the handling and the movability of the telescope.

An improved telescope mount with high positioning velocity and precise guiding and high positioning accuracy is therefore desired. A simple possibility to exchange the optics is also advantageous. It is also an advantage if the telescope mount is providing a vibration-free and a smooth drive.

UK patent application GB 2 056 109 A discloses a two-axes mount for a telescope having a motor at each shaft for respectively driving each shaft without an intermediate gear. Thereby two separate motors are attached to the same housing. This document does not teach how the motors are connected with the respective shaft declared of the housing.

The U.S. Pat. No. 3,795,150 teaches a system for positioning of cardanically mounted objects. The system has two orthogonal axes that can be each driven by a motor. It is disclosed that the system can be used with telescopes and that torque motors at the basis or the frame of the system can be connected to the axis in a conventional way.

### SUMMARY OF THE INVENTION

The present invention provides a turning device or an apparatus with at least one turning device for rotatably mounting or supporting at least one telescope wherein the at least one turning device comprises at least one working shaft and one driven shaft of a drive or motor, wherein the working shaft and the driven shaft are aligned and are formed integrally.

The invention also comprises an apparatus for rotatably mounting or supporting a telescope with at least two substantially orthogonal axes, the telescope being rotatable about at least a first axis of the two orthogonal axes by a first turning device, wherein the first turning device comprises a first working shaft and a first driven shaft of a drive or motor, wherein the axes of the working shaft and the driven shaft are aligned are formed integrally. The respective axes are herein the axes about which the working shaft and the driven shaft rotate.

The apparatus may be used for the attachment of a telescope. Thereby the telescope can be mounted at only one side of the apparatus. The mount may provide only a single connection, for example a single flange for mounting a telescope. A time consuming and difficult alignment, for example in a double-tine fork can be avoided and mounting or exchanging of the telescope optics is much easier and faster using the apparatus of the invention. The apparatus of the invention can also have one telescope flange for each telescope to be mounted to the apparatus.

The apparatus of the invention can be a German-type mount. The apparatus of the invention may also be a single-tine fork mount.

The apparatus may also comprise a second turning device according to the invention by which the telescope is rotatable or pivotable about the second axis of the two orthogonal axes. The telescope can thereby be directed or oriented on each point and to each object of observation in the sky, if the two axes are oriented to each other in an appropriate manner. In parallel, the movement of the observed object over the sky can be guided by the two rotational axes.

The two orthogonal axes can be arranged and oriented such that the first axis is the right ascension axis and the second axis is the declination axis. Thus, the apparatus of the invention can be used as equatorial mount.

A polar adjustment/alignment can be provided by which the first axis, for example the right ascension axis, can be adjusted according to the geographical position of the location of observation. A rotation means can also be provided by which the apparatus can be pivoted or rotated around the vertical axis. Typically, the orientation and alignment of the first axis is only carried out once for a geographical point of observation and then stays constant and unchanged over the complete period of observation, i.e., the polar adjustment and thereby the position of the first axis can remain in the adjusted position. After adjusting, all further movements of the telescope can be conducted by the turning devices.

The first axis of the apparatus may also be oriented vertically (perpendicular to the horizon) resulting in an Alt-Az mount.

The first axis of the apparatus can also be tilted. This is still considered an Alt-Az mount corresponding to a different site of observation on the earth.

The first axis can be horizontally orientated for obtaining an Alt-Alt mount.

The aligned and integrally formed axes of the working shaft and the driven shaft can avoid vibrations and transverse forces thus providing a continuous and vibration-free rotational motion.

The working shaft and the driven shaft can be directly coupled. The motor or drive with its driven shaft forms thereby a direct drive together with the working shaft. There are no gears or transmissions between the driven shaft and the working shaft. The driven shaft and the working shaft can be removably connected to each other, for example with a coupling element such as a coupling sleeve or similar or can be connected permanently during fabrication, for example welded. A backlash free, float free and hysteresis free coupling between the drive or motor and the working shaft is obtained which enables a substantially higher positioning accuracy and moreover a much more precise guiding.

The driven shaft and the working shaft of the rotation device can also be formed integrally in one piece, i.e. a single identical shaft of same material. Thereby joints or connection of the working shaft and the driven shaft are avoided so that inaccuracies in respect to the alignment and/or the coupling of the working shaft and the driven shaft are avoided.

The drive or motor may be an electric motor. An electric motor enables a simple and pollution free and in the same time precise movement of the driven shaft and thereby of the working shaft. A commonly known commercial available electric motor can be used which can be chosen according to the requirements of the telescope mounting and the weight of the telescope.

The electric motor of the rotation device can be a torque motor. The precise control and in the same time higher possible velocities of the torque motor allow for a higher positioning accuracy and high adjusting velocities as well as a particularly uniform motion.

A rotor of the electric motor may be connected to the working shaft of the rotational device. The rotor, that may comprise a plurality of magnets, may be screwed to the working shaft, i.e. the driven shaft, but can also be fixed by other means. The complete rotor or each of the magnets forming the rotor can be separately connected to the shaft in a manner known to a person skilled in the art.

The rotation device may comprise a housing in which the working shaft is rotatably supported and wherein a stator of the electric motor is arranged. The stator can comprise controllable electric magnets attached separately or in groups to the housing. The control of the electric magnets can be carried out in a manner known to a person skilled in the art with respect to torque motors. A further housing in which the drive or motor is placed can be advantageously avoided leading to a more compact size of the rotation device and the apparatus.

An electronic control can further be provided which can be arranged inside the housing and/or at a different place outside the housing. The control can be connected to and controlled by a micro computer. A specific electronic control can be provided by which the telescope is connected via the rotation device. For example the rotational speed, the rotation direction, the acceleration and other parameters related to the rotation of the telescope can be adjusted.

The housing can provide attachment means by which the housing of a first rotation device can be attached to a stand or support or to a polar adjustment. The working shaft of the first rotation device can be attached or can be attachable to the housing of a second rotation device. The attachment is such that the working shaft of the first rotation device and the working shaft of the second rotation device are oriented perpendicular with respect to each other when the first rotation device and the second rotation device are mounted to each other. The optics of a telescope can be mounted or attached to the working shaft of the second rotation device. Fast attachment mechanisms or standardized fixation devices can be provided so that an easy and fast exchange of the optics or the telescope is possible. The apparatus or mount according to the invention can thus be used with different telescopes or optical devices.

The first rotation device and the second rotation device can be equal or similar in design and may only differ in details such that both rotation devices can be combined as modules for forming the apparatus or mount of the invention.

The rotation device can be adapted to any size of telescopes and the invention is independent from the optics used.

In a preferred embodiment, the present invention is an apparatus for a rotatable mount of a telescope. The apparatus comprises a working shaft and a driven shaft of a drive wherein an axis of the first working shaft and an axis of the first driven shaft are aligned and integrally formed. The drive may comprise an electric motor, or, more specifically, a torque motor. Other types of motors, however, may be used with the invention. In a preferred embodiment, A rotor of the electric motor is connected to the first working shaft. The apparatus may further comprise a housing, wherein the working shaft is rotatably supported in the housing and a stator of the electric motor is arranged in the housing.

In another preferred embodiment, the present invention is an apparatus for the rotatable mount of a telescope having at least two axes being substantially orthogonal to each other, wherein the telescope is rotatable about at least a first axis of the two orthogonal axes by at least a first rotation device. The rotation device comprises a first working shaft and a first driven shaft of a first drive, wherein the respective axis of the first working shaft and the first driven shaft are aligned and formed integrally. The first axis may be arranged vertically or horizontally. The apparatus may adapted for a one side attachment of a telescope or may be a German-type telescope mount. The telescope further may be rotatable about a second axis of the two orthogonal axes by a second rotation device, the second rotation device comprising a second working shaft and a second driven shaft of a second drive wherein the second working shaft and the second driven shaft are aligned and integrally formed. The first axis may be the right ascension axis and the second axis may be the declination axis. The apparatus may further comprise a polar adjustment. The apparatus may be adapted for a one side attachment of a telescope or may be a German-type telescope mount.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 shows a telescope mount according to the invention.

FIG. 2 shows a rotation device according to the invention magnified and in more detail.

FIG. 3a and b show a perspective view of the rotation device of FIG. 2.

### DETAILED DESCRIPTION OF THE PREFERRED EMBODIMENTS

In the following description of an exemplary embodiment of the invention, equal or similar elements are described with the same references.

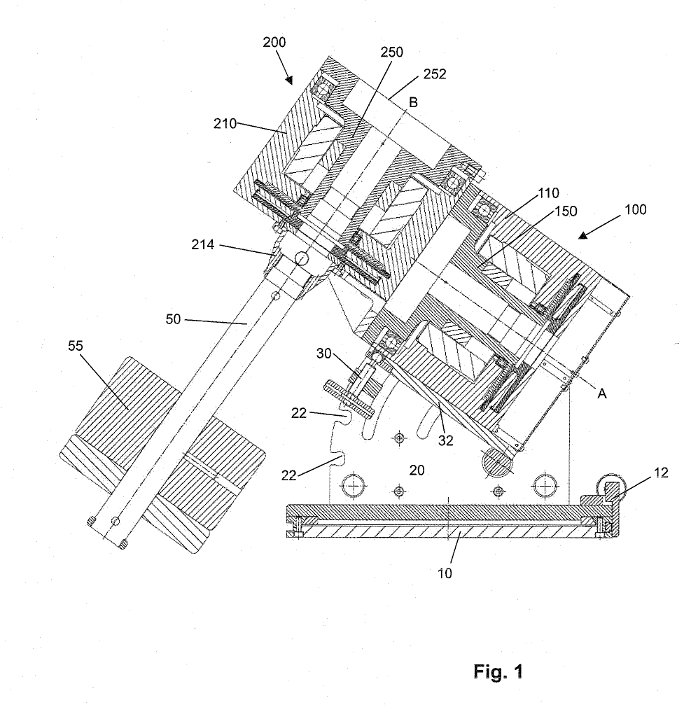

FIG. 1 shows a telescope mount according to the invention. The mount is shown in equatorial configuration; it is evident to a person skilled in the art that the mount shown can also be used and configured as an Alt-Azimuth mount or as an Alt-Alt mount.

The mount has a base 10 by which the mount can be mounted or connected to a stand or another support. The base 10 can have a rotation means being fixable by a locking device and being adjustable by a Vernier adjustment 12 and by which the mount is arranged rotating about the vertical axis. Typically the mount is adjusted once in the azimuth corresponding to the geographic position of the observation position and remains for the total observation period in this adjusted position. A polar adjustment 20 is provided on the base 10 which allows to adjust a first rotation element 100 to be adjusted such that the rotational axis A is essentially parallel to the rotational axis of the earth, i.e., the polar adjustment is in a manner known in the art adjusted only once for a period of observation for a certain geographic observation site on the earth and may remain in this position. For the adjustment of the pole adjustment notches 22 and a fine adjustment 30 is provided by which the first rotational axis A is adjusted.

A housing 110 of the first rotational device 100 is fixedly mounted to a fixation plate 32 of the polar adjustment 20. The term “fixedly mounted” relates here only to the fixed connection during the use of the telescope. The first rotation element 100 can be adapted to be removably connected to the polar adjustment 20 for example by a screw joint or similar. A shaft 150 is provided inside the housing 110 of the first rotation device 100, which is in use fixedly connected to the housing 210 of a second rotation device 200. The fixed connection can be achieved by screw joints or similar and can such be removable. The shaft 250 lies on the second axis of the mount and corresponds in equatorial configuration to the declination axis (DEC) and in an Alt-azimuth configuration to the altitude axis. The shaft 250 comprises a telescope flange 252 to which a telescope (not shown) can be attached. The telescope flange 252 can be a standard joint such that a plurality of different telescopes can be attached to the telescope flange 252 so that the mount can be used with a plurality of telescopes.

A prolongation 50 is connected to the second rotation device 200 to which weights 55 can be attached. The (counter)-weight 55 serves as a balance or compensation for the weight of the telescope in order to reduce the load on the bearings and the motor of the first rotation device 100 and the second rotation device 200 and for obtaining a more precise adjustment of the telescope. The weight 55 can be chosen correspondingly to the telescope that is to be flanged to the mount. The weight 55 can be replaced for example by a second telescope or any other instrument, part, etc.—only the effect of weight balance is important in this respect.

The prolongation 50 is aligned along the second axis B and can be connected to a truncated cone 214 which is fixedly attached to the housing 210. The prolongation 50 can also be connected to any other portion of the housing 210. In this case, the prolongation 50 and the weight 55 may not rotate about the axis B.

It may be desirable that the weight 55 is rotatable about the axis B, i.e. if the weight shall be replaceable by a further telescope or another optical instrument. The prolongation 50 can, in this case, be attached to the shaft 250, such that the prolongation 50 and eventually also the weight 55 can rotate together with a telescope attached to telescope flange 252 about axis B.

The truncated cone 214 at the first rotation device 100 can be omitted or can be replaced by a cover or the like, if the attachment of a weight shall not be provided.

The first rotation device 100 for the rotation about the first axis A, the right ascension axis in equatorial configuration, and the second rotation device 200 for the rotation about the second axis B, the declination axis in equatorial configuration, have in general the same design and conception and may only differ in axes-specific details such as the attachment of the housing and the attachment of additional components to the respective rotation device.

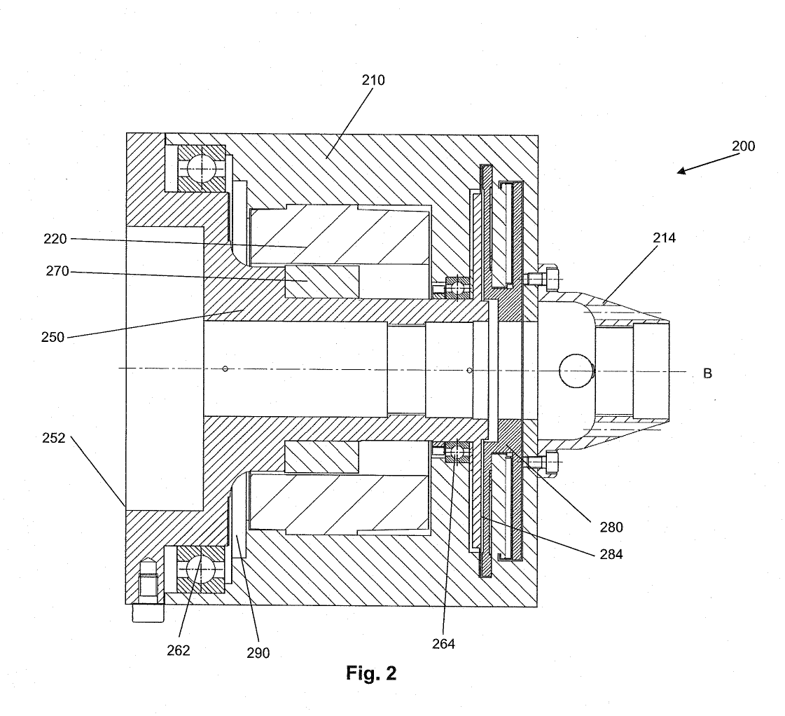

The second rotation device 200 is shown in FIG. 2 in more detail. A person skilled in the art will recognize that the rotation device shown in FIG. 2 and its essential features can also be used as first rotation device 100.

The second shaft 250 is rotatably supported in the housing 210 of the second rotation device 200 by means of a first roller bearing 262 and a second roller bearing 264. A rotor 270 of a torque motor is fixed or attached to the shaft 250 for example by a screw joint or another connection. The rotor 270 can comprise several elements that are arranged along and/or around the shaft 250. Each of the elements of the rotor 270 can be a static magnet. A stator 220 of the torque motor is arranged radial to the rotor 270 of the torque motor. The stator 220 can consist of several elements, for example of magnetic elements or electric magnets that are fixedly arranged axially about the rotor 270 in the housing 210. The rotation device 200 can additionally comprise a break device 280 that enables to break, for example pneumatically, a break disc 284 fixed to the shaft 250 such that the motion of the shaft 250 in the housing 210 is slowed down or stopped. A precise adjustment and guiding of the telescope can be achieved. The break 280 can also only serve for security reasons for example to avoid a free rotation or turning of the mount in case of a power shut down.

The rotation device 200 additionally comprises an angle measuring system 290 for the determination of an angular position and/or the rotational speed of the shaft 250 with respect to the housing 210. Commercially available angle measuring systems known in the art of torque-motors can be provided. The position determined by the angle measuring system 290 and/or the rotational speed can be used for the control of the motor in a known manner.

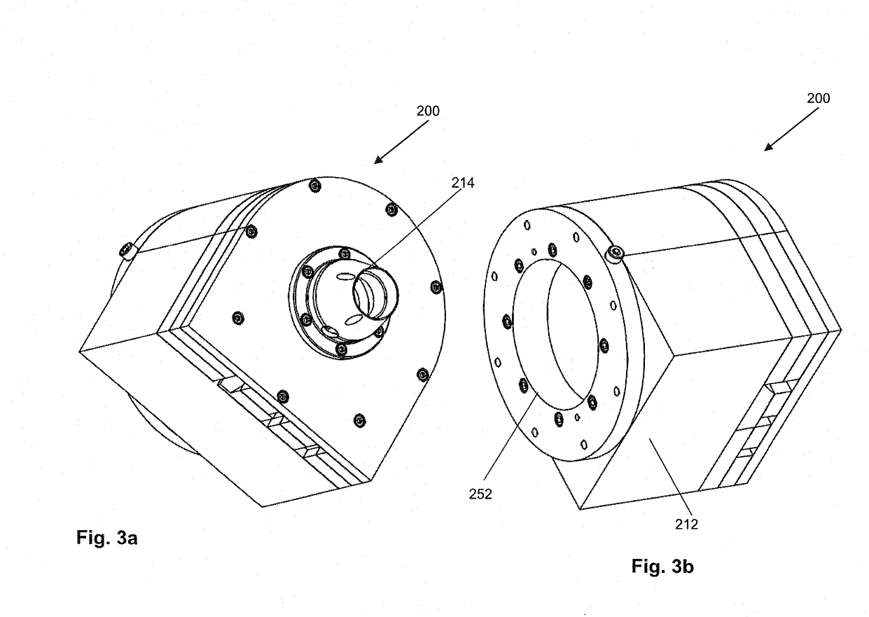

FIGS. 3a and 3b show two perspective views of the second rotation device 200.

FIG. 3a shows the face of the rotation device 200 at which the truncated cone 214 for the attachment of the prolongation 50 and the weight 55 is arranged.

FIG. 3b shows the telescope facing side of the shaft 250 with the telescope flange 252.

FIGS. 3a and 3b also show the lower side 212 of the housing 210, by which the second rotation element 200 is attached to the shaft 150 or to which the flange 152 of the first rotation device 100 can be attached.

The embodiment shown relates to a specific embodiment of the invention and is not limiting the invention by any means. For example, the first rotation device 100 and second rotation device 200 can be used separately for example for only conducting the rotation about one axis. In addition, the first and the second rotation device can be mounted in Alt-azimuth configuration such that the first axis A of the first shaft 150 of the first rotation device 100 is oriented vertically or in the rotational direction and the second axis B of the second rotation device 200 is oriented horizontally such that a rotation of the telescope between the horizon and the zenith is possible.

It is evident to a person skilled in the art that the present invention can also be used for an Alt-Alt mount.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. An apparatus for a rotatable mount of a telescope comprising:
a first working shaft; and
a first driven shaft of a drive;
wherein an axis of the first working shaft and an axis of the first driven shaft are aligned and integrally formed.

2. An apparatus according to claim 1, wherein the drive comprises an electric motor.

3. An apparatus according to claim 2, wherein the electric motor comprises a torque motor.

4. An apparatus according to claim 2, wherein a rotor of the electric motor is connected to the first working shaft.

5. An apparatus according to claim 2, further comprising a housing, wherein the working shaft is rotatably supported in the housing and a stator of the electric motor is arranged in the housing.

6. An apparatus for the rotatable mount of a telescope having at least two axes being substantially orthogonal to each other, wherein the telescope is rotatable about at least a first axis of the two orthogonal axes by at least a first rotation device, the rotation device comprising:
a first working shaft; and
a first driven shaft of a first drive;
wherein the respective axis of the first working shaft and the first driven shaft are aligned and formed integrally.

7. An apparatus according to claim 6, wherein the first axis is arranged vertically.

8. An apparatus according to claim 6, wherein the first axis is oriented horizontally.

9. An apparatus according to claim 6, wherein the apparatus is adapted for a one side attachment of a telescope.

10. An apparatus according to claim 6, wherein the apparatus is a German-type telescope mount.

11. An apparatus according to claim 6, wherein the telescope is further rotatable about a second axis of the two orthogonal axes by a second rotation device, the second rotation device comprising a second working shaft and a second driven shaft of a second drive wherein the second working shaft and the second driven shaft are aligned and integrally formed.

12. An apparatus according to claim 11, wherein the first axis is the right ascension axis and the second axis is the declination axis.

13. An apparatus according to claim 12, further comprising a polar adjustment.

14. An apparatus according to claim 11, wherein the first axis is arranged vertically.

15. An apparatus according to claim 11, wherein the first axis is oriented horizontally.

16. An apparatus according to claim 11, wherein the apparatus is adapted for a one side attachment of a telescope.

17. An apparatus according to claim 6, wherein the apparatus is a German-type telescope mount.
